(19) United States
(12) Patent Application Publication
(10) Pub. No.: US 2004/0210480 A1
(43) Pub. Date: Oct. 21, 2004

(54) Method for marketing and selling mobile recording media

(76) Inventor: Heiko Muller, Dresden (DE)

Correspondence Address: GUDRUN E. HUCKETT DRAUDT, LONSSTR. 53, WUPPERTAL, 42289, DE

(21) Appl. No.: 10/651,142

(22) Filed: Aug. 28, 2003

(30) Foreign Application Priority Data
Aug. 30, 2002 (DE) 202 13 627.2

(51) Int. Cl. G06F 17/60

(52) U.S. Cl. 705/14

(57) ABSTRACT

In a method for marketing and selling mobile recording media, mobile recording media are offered that are designed by a provider without direct influence of a user such that on a surface of the recording media at least partially at least two coats of color applications are applied that supplement one another to a decorative coating in the form of a graphic illustration. The graphic illustration does not represent primarily a product identification, a trademark identification, a manufacturer identification, or line markings for improving written labeling. The graphic illustration is different on individual ones of the recording media or on sets of the recording media.

### FIELD OF THE INVENTION

The present invention relates to marketing and selling of mobile recording media, for example, optical recording media such as CD-R, CD-RW, DVD-R, DVD-RW etc. Partially, the present invention also relates to marketing and selling of mobile recording media in connection with marketing and selling data.

### BACKGROUND TO THE INVENTION

Mobile recording media are known, for example, in the form of optical recording media such as CD-R, CD-RW, DVD-R, DVD-RW etc. Such mobile recording media have developed in recent years to an omnipresent product of daily use.

The recording media known in the marketplace are typically marketed and sold as undifferentiated mass-produced articles for fast data storage. All recording media known in the marketplace have in common that they are not at all graphically designed, or only so as to have a very simple standard contents. These standard contents are limited in general to the logo of the manufacturer, information in regard to type and storage capacity of the recording medium, as well as, for example, lines or simple geometric patterns that are designed to simplify a possible future labeling.

In general, it can be said that the optical differentiation possibilities of the mobile recording media known in the marketplace are very limited. For example, it is typically possible to visually differentiate mobile recording media with a certain manufacturer logo from a mobile recording media having a different manufacturer logo. Mobile recording media with the same manufacturer logo can be visually differentiated from one another usually only when, for example, different type designations are provided thereon.

In view of this background of a lack of a visual differentiation possibility and because of the fact that the different mobile recording media known in the marketplace can be differentiated from one another in general only minimally even with regard to their technical properties, there exists increasingly a situation within which mobile recording media can be sold only because of a price that is as low as possible. Therefore, large portions of the revenue potential possible by selling mobile recording media remain completely unused.

While mobile recording media originally have been used almost exclusively for fast and inexpensive data securing, in the meantime a variety of additional applications has been established. In this connection, many of these new applications are motivated emotionally.

For example, market research has shown that approximately 40% of users use mobile recording media also as individual presents for friends, acquaintances or relatives. Another widely used application is, for example, the use as an archive for digital photos; this again has a great emotional value attached.

The user of mobile recording media has generally the desire to design individual mobile recording media such that it is probable to visually recognize them quickly within a large quantity of mobile recording media.

This desire is particularly prevalent in the area of emotionally motivated applications. For example, the user desires that a CD that has been burned as an individual present is to be provided with a design that reminds the recipient even after a long period of time still of the occasion of the gift. A typical example of such a design would be the image of a flower with the labeling “All the best on your 20th birthday”.

A typical approach according to the prior art resides in that mobile recording media are provided by the user with individualized written labeling. For example, it is possible that the user writes “All the best on your 20th birthday” with a pen onto a burned CD to be given as a gift. It is also possible that the user acquires or provides a suitable design that he then applies directly or by using a suitable adhesive label onto the recording medium to be fashioned.

When the user needs a larger quantity of such fashioned recording media, he has also the possibility to order the manufacture from a specialized supplier. This is possible, for example, for companies that need specially designed mobile recording media for internal or external use.

In all solutions known in the marketplace, a significant time expenditure, and under circumstances also cost expenditure, is required of the user. In particular, for a user of very small and small quantities the production of fashioned mobile recording media is therefore extremely difficult.

It is an object of the invention to solve this design problem of a user of very small and small quantities and at the same time to expand the already present market for mobile recording media, to maximize the available revenue potentials, to provide new markets for mobile recording media, and to activate the revenue potentials residing therein.

### SUMMARY OF THE INVENTION

The invention suggests to offer the user several mobile recording media that are provided already by the provider and without direct influence of the user with complex graphic designs and that differ from one another, individually or with regard to sets, with respect to the configuration of the complex graphic designs.

In this connection, these complex graphic configurations are not primary product identification, trademark identification, manufacturer identification, or line markings for improving written labeling.

By means of the special configuration of the complex graphic design of the recording media it is possible to specialize mobile recording media for certain, in particular, emotionally motivated applications of use.

The user can select from this quantity a recording medium whose complex graphic design, in the eyes of the user, is best suited for his design needs. In particular, the user of very small or small quantities is enabled in this way to acquire individual mobile recording media that have complex graphic designs.

A new principle in comparison to all known methods on the market for distribution and sale of mobile recording media is in this connection that the user is offered a collection of mobile recording media that are already designed by the provider with different complex graphic illustrations from which collection the user can select according to his wishes a recording medium or several such recording media. The user must neither order the design nor the manufacture.

Aside from the feature of a visual individualization of the complex graphic configuration of the mobile recording media, by means of the specialization of the designs in regard to emotional applications and the resulting simplification for users of very small or small quantities an added value results that is suitable to remove mobile recording media fashioned in this way from the direct price war with recording media that are undifferentiated with regard to their design. In this way, it is possible to expand the available markets, to maximize the revenue potentials residing therein, to open new markets, and to activate the revenue potentials residing therein.

### DESCRIPTION

The invention has the object to minimize the design expenditure when using mobile recording media for the user of very small and small quantities and, at the same time, to expand the existing markets for mobile recording media, to maximize the revenue potentials residing therein, to provide new markets for mobile recording media, and to activate the revenue potentials residing therein.

This object is solved by the features of claim 1.

Several mobile recording media are offered to the user which recording media are provided already by the provider and without direct influence of the user with complex graphic designs, in particular, no primary product identification, trademark identification, manufacturer identification or line markings for improving written labeling thereon and which differ from one another, individually or with regard to sets, with respect to the configuration of the complex graphic designs.

The user can select from this quantity the recording medium whose complex graphic design in the eyes of the user is best suited for his design needs. In particular, the user of very small or small quantities is thus enabled to acquire without problems individual mobile recording media which have complex graphic designs.

A special configuration of the invention according to claim 1 is the special orientation of the complex graphic design of the recording media in regard to emotionally motivated applications. For example, it is possible to provide the recording media with communicative designs such as “I love you”, “All the best on your birthday”, “I miss you”, “Happy Mother's Day”. This emotional effect can be enhanced by use of suitable design means such as illustrations or photography.

It is also possible to decorate the mobile recording media with the illustration of artistic works. Also, the illustration of designs is possible in regard to the fields of fashion or lifestyle. Basically, all types of graphic designs are possible wherein emotionally charged designs are particularly suitable.

The novel principle relative to the methods known in the market for marketing and selling mobile recording media is in this connection that the user is offered a collection of mobile recording media that are already provided with different complex graphic illustrations by the provider from which collection the user can select a recording medium or several recording media to his liking. The user must neither order the design nor the manufacture of the fashioned mobile recording medium.

Aside from the feature of a visual individualization of the complex graphic configuration of the mobile recording media, by means of the specialization of the designs in regard to emotional applications and the resulting simplification for a user of very small or small quantities an added value results that is suitable to remove mobile recording media fashioned in this way from the direct price war with recording media that are undifferentiated with regard to their design. In this way, it is possible to expand the available markets, to maximize the revenue potentials residing therein, to open new markets, and to activate the revenue potentials residing therein.

Advantageous embodiments of the invention are provided in the claims 2 to 41.

The embodiment according to claim 2 provides the possibility to provide the mobile recording media over portions thereof with an additional decorative coating comprised of at least one color coat. As a special configuration of claim 2, it is possible that this is also, for example, product identification, trademark identification, manufacturer identification or line markings for improving written labeling thereon.

The embodiment according to claim 3 provides the possibility to provide the mobile recording media with a case for protecting the recording media against environmental effects.

The embodiment according to claim 4 represents cases for the mobile recording media which advantageously are provided with a complex graphic design by means of which the cases can also be quickly and safely recognized within or differentiated from a quantity of cases and which thus makes the cases also suitable for use in the emotionally motivated application. As a particular configuration of the invention according to claim 4 it is expedient to design the complex graphic design of the cases advantageously identical to or similar to the complex graphic design of the correlated mobile recording media. The respective case and the correlated mobile recording medium thus form advantageously a unit. Moreover, it is possible that the cases have also printed thereon, for example, a product identification, trademark identification, or manufacturer identification. Also, it is possible that, for example, on the inner side of the cases a line system for improving written labeling thereon is provided. The cases can be manufactured of any suitable material or suitable material combinations. Advantageous are cases comprised of a foldable cardboard part and a support of plastic material glued thereto are advantageous that is suitable for receiving a mobile recording medium. It is also possible to provide cases of plastic material, sheet material, textile material etc.

The embodiment of the invention according to claim 5 advantageously presents cases in which additional recording media or different supplemental articles are provided. For example, a data carrier is possible as a supplemental article on which a software is provided that simplifies the use of the recording medium.

The embodiment of the invention according to claim 6 enables to provide the supplemental articles or the additional recording media with complex graphic designs for a fast differentiation and thus for improved suitability for emotionally motivated applications. As a special configuration of the invention according to claim 6, it is expedient to design the complex graphic design of the supplemental articles or of the additional recording media advantageously identical or similar to the complex graphic design of the correlated mobile recording media or of the cases so that advantageously a visual unit of the correlated objects is achieved. Moreover, it is possible that the supplemental articles or the additional recording media have printed thereon, for example, a product identification, trademark identification, manufacturer identification or line markings for improving writing a labeling thereon.

The embodiment of the invention according to claim 7 ensures advantageously a secure hold of the at least one supplemental article in and/or on the at least one case. For example, a case with insertion slot is possible in which a greeting card is inserted as a supplemental article. Also, it is possible that a photo can be attached, for example, by insertion slots, insertion windows, adhesive photo fasteners or similarly suitable devices to the case; this enhances the use particularly in the area of storage of digital photography.

The embodiment of the invention according to claim 8 ensures advantageously a secure hold of the at least one recording medium in or on at least one case. For example, it is possible that within one folding cardboard case two plastic parts for receiving a recording medium each are provided.

The embodiment of the invention according to claim 9 provides several possibilities to enhance the cases. For example, the cases can be designed as congratulatory cards so that, in addition to their actual function, they also fulfill the function of a congratulatory card. The cases, for example, can also be comprised of a hard book cover in which, for receiving a mobile recording medium, a support and optionally also book pages that can be written on by the user or can already be provided with a contents are provided.

The embodiment of the invention according to claim 10 relates to specially suitable supplemental articles. The mobile recording medium can be accompanied, for example, by greeting cards. Further advantageous supplementing articles are, for example, bonus cards, collector cards, and/or calendars.

The embodiment of the invention according to claim 11 relates to specially suitable supplemental articles. Advantageously, folding congratulatory cards can be enclosed with the mobile recording media; this positively enhances the optional use as a gift. Further advantageous supplemental articles are, for example, small booklets or case inserts that can be written on by the user.

The embodiment of the invention according to claim 12 relates to particularly suitable supplemental articles in the form of, for example, differently colored writing pens which are suitable, for example, for written labeling of the cases.

The embodiment of the invention according to claim 13 refers to particularly suitable supplemental articles in the form of mailing or storage containers. For example, a stand for mobile recording media, an organizing system, for example, an index card system or filing system, or also a mailing pouch that can again be designed similar to a greeting card is possible.

The embodiment of the invention according to claim 14 enables advantageously packing of the different offered parts in retail packages. For example, it is possible that a mobile recording medium is offered for sale together with a case in a common retail package made of film. Also, it is possible that three mobile recording media that can be individually packaged in separate retail package, wherein one of them, for example, can also be a supplemental article in the form of a conventional recording medium without particular graphic decorative coating, can be packaged additionally in a common retail package. The retail packages can be, for example, fused film wraps, blister packs, cardboard packages etc. As a particular embodiment of the invention according to claim 14 it is possible that the case surrounding the recording medium is at the same time the retail package.

The embodiment of the invention according to claim 15 enables that retail packages are provided with complex graphic designs for fast differentiation. As a particular embodiment of the invention according to claim 15 it is expedient to design the complex graphic design of the retail packages advantageously similar or identical to the complex graphic design of the articles to be packaged. The retail package and the correlated articles therefore advantageously form a unit. Moreover, it is possible that the retail packages also have printed thereon, for example, a product identification, a trademark identification, a manufacturer identification or line markings for improving written labeling.

The embodiment of the invention according to claim 16 enables that the recording media and/or cases and/or supplemental articles and/or retail packages are provided with designs based on which the respective object can be correlated with a design and/or artistic and/or musical and/or entertaining work and/or with such a work and/or such a product, a figure and/or a person and/or several persons and/or a company associated therewith, respectively. For example, it is possible to design the recording media with the illustration of an entertainer known in the field of television so that a sales-enhancing effect can be obtained. This can be advantageously also the illustration of at least one person that is known in the field of musical entertainment. For example, mobile recording media are possible that are provided with the image of a known pop musician or a rock band so that thereby a sales enhancing effect can be obtained. At the same time, by offering mobile recording media designed in such a way an indirect sales-enhancing effect for the products that are associated with the illustration can be achieved. For example, it is possible in connection with recording media designed in this way to also sell recordable data that can be associated with the illustration.

The embodiment of the invention according to claim 17 enables advantageously to provide the recording media, cases, supplementing articles, or retail packages with a special effect in that they are at least partially designed to be luminescent. For example, it is possible to provide a card as a supplemental article on which a moon is illustrated that is provided with a luminescent coat so that it will glow in the dark. Moreover, a case can be provided that is comprised partially of a reflective material so that the surrounding colors will be reflected on it.

The embodiment of the invention according to claim 18 enables advantageously to provide the recording media, cases, supplemental articles or retail packages with a special effect in that they are designed partially holographically; for example, in this way an authenticity certification is enabled as a sales-enhancing added-value product feature.

The embodiment of the invention according to claim 19 enables advantageously to provide the recording media, cases, supplementing articles, or retail packages with a special effect in that they are provided at least partially with fragrances. For example, a case that has printed thereon a rose pattern can be provided with a rose fragrance that can be released, for example, by rubbing.

The embodiment of the invention according to claim 20 enables advantageously to provide the recording media, cases, supplementing articles, or retail packages with a special effect in that they are at least provided partially with a self-adhesive layer. For example, the disk-shaped supplementing article according to claim 10 can be designed as an adhesive label that has the same shape and size as the recording medium and can be applied, after having been printing, onto the recording medium by the user. In this way, the user can correct, for example, errors that have occurred when carrying out a handwritten labeling of the recording medium.

The embodiment of the invention according to claim 21 enables advantageously to provide the recording medium, cases, supplementing articles, or the retail packages with a special effect in that they are provided at least partially with a surface as it is known, for example, from so-called lottery scratch tickets. For example, it is possible to provide the cases with lottery numbers, passwords, or messages that can be exposed by the user by scratching. Also, it is possible to provide a card as a supplemental article that has a surprise design or a surprise message that is to be exposed by the user by scratching.

The embodiment of the invention according to claim 22 enables advantageously to design the surfaces of the recording media, cases, supplemental articles, or retail packages such that writing a labeling thereon and/or printing is simplified. This can be achieved, for example, in that the applied color coat by means of an appropriate material selection or, for example, by roughening has beneficial surface properties. It is also possible that the applied decorative layers are designed monochrome in parts in order to provide at these locations a favorable location for writing a labeling thereon.

The embodiment of the invention according to claim 23 enables advantageously to form series within the offered selection so that sales-enhancing and customer-bonding effects are obtained.

The embodiment of the invention according to claim 24 enables to provide the recording media and/or cases and/or supplementing articles and/or retail packages with designs based on which the respective article can be associated with a place and/or a city and/or a region and/or a country and/or a tourist environment and/or a tourist site. For example, it is possible in this way to provide mobile recording media with designs that can be correlated with certain vacation spots. The user has therefore, for example, the possibility to store his emotional vacation memories in the form of digital vacation photos on a mobile recording medium that is provided with a design associated with the vacation site. As a design it is, for example, possible to provide an image typical of New Zealand in connection with the labeling “Vacation in New Zealand”. In this way, the tourist market is opened as a completely new market for mobile recording media.

The embodiment of the invention according to claim 25 enables to provide the recording medium and/or cases and/or supplemental articles and/or retail packages with designs based on which the respective article can be associated with a product and/or a trademark and/or a firm and/or a figure and/or a person and/or several persons and/or an event and/or a point in time and/or a time period. For example, it is possible to provide the mobile recording medium with designs such as “This was the year 2000”, “New Year 2000”, “Our Wedding”. Moreover, it is possible to use the product for direct or indirect advertisement. For example, it is possible to provide within a graphic design a current cloth pattern of a fashion designer and to open in this way a marketing possibility for this fashion designer. It is also possible that optical recording media provided with a design that advertises a product of a company can be given away for free or at significantly reduced cost to the user. In this way, it is possible to combine the offering of mobile recording media to users of very small quantities and small quantities with a marketing or advertisement option for third parties. In this way, an additional increase of the revenue potential can be achieved.

The embodiment of the invention according to claim 26 enables to offer the recording of data according to customer selection as a service so that a stronger customer bonding and a target group expansion can be achieved.

The embodiment of the invention according to claim 27 enables to provide the user with a technical device for data recording. This can be integrated into the ordering process, for example, in the case of a purchase on the Internet. Also, terminal solutions at the retail location are possible.

The embodiment of the invention according to claim 28 makes it possible to enable the user to store his own data via the technical system that is made available. The data can be, for example, digital photo data that the user upon online purchase of the mobile recording medium transmits during the ordering process online to the provider for the purpose of data storage.

The embodiment of the invention according to claim 29 enables to provide the user with suitable data for storage. In this way, on the one hand, the sale of mobile recording media can be increased because data acquisition is facilitated for the user. On the other hand, this combination can be used in order to obtain an earnings increase based on the sale of usage rights on the data made available. It is also possible that a marketing function for the owners of the rights in the data results which can be utilized economically in a separate way. It is also possible that the user, when purchasing the mobile recording medium, obtains the right of use in one or several files, for example, in the form of an access code, and at any future point in time exerts this right of use, for example, by downloading the files from the Internet by redeeming the access code. In this way, a strong customer bonding to the product and to an already existing Internet offering can be achieved.

The embodiment of the invention according to claim 30 enables to provide the user with a technical platform for acquiring the recordable data. This can be realized in particular by a platform on the Internet. Terminal solutions at the retail locations are also possible. It is also possible that the options data storage and data acquisition are correlated with one another. For example, it is possible that a user purchases a mobile recording medium in the store and subsequently makes a data selection at a terminal. The selected data can then be recorded by him at the same terminal onto the mobile recording medium. It is also possible to use and/or market technical offerings of third parties in connection with the mobile recording medium.

The embodiment of the invention according to claim 31 describes particularly suitable data. The data can be music data but also imaging data, film data, video data, or software data. For example, it is possible by a targeted cooperation e.g. with the music industry to market select music titles.

The embodiment of the invention according to claim 32 enables having an influence on which contents can be burned onto the mobile recording medium. In this connection, it is possible, for example, that a mobile recording medium having a design that can be associated with an existing person or company, can be used only for recording data of a limited data selection. In this way, it can be prevented that, for example, the person or firm provided on the illustration can be defamed by recording racist or pornographic data. In this way, it is also possible to prevent that mobile recording media are used to record illegal copies. In this case, the dispensing of a mobile recording medium to a user is always connected with a preceding data storage.

The embodiment of the invention in accordance with claim 33 enables the user to expand the selectable files by his own files, but also protects with regard to defamation as a result of recorded racist or pornographic data.

The embodiment of the invention according to claim 34 ensures that even at a later point in time it is not possible to record undesirable data onto the mobile recording medium in that the mobile recording medium is technically changed such that an additional recording of data is prevented.

The embodiment of the invention according to claim 35 enables that a correlation between the design of the mobile recording medium and of the recorded data is possible. For example, it is possible that the mobile recording medium that is provided with the image of a known music group can be recorded only with data that can be correlated with this music group. For example, when selling via the Internet or via terminal solutions, a data base correlation is possible which, as a function of which mobile recording medium the user will select, allows access only to the correlated data. In this way, image damages can be prevented.

The embodiment of the invention according to claim 36 enables that a portion of the storage space available on the mobile recording medium can be used by the provider for recording data. This enables a further expansion of the marketing possibilities.

The embodiment of the invention according to claim 37 relates to software as a particularly suitable form of data prerecorded by the provider. This can be, for example, a copying protection. This can also be data that determine which additional data can be recorded on the remaining storage space of the recording medium.

The embodiment of the invention according to claim 38 defines a control software for recording devices, data archiving software, and software that simplifies the use of the mobile recording medium, i.e., a particularly suitable software. For example, it is possible that for applications in the field of archiving of digital photography a software is prerecorded which, on the one hand, is suitable for image processing and archiving digital image material and with which the user, on the other hand, can record the processed data directly onto the remaining storage space of the mobile recording medium, i.e., it has at the same time a recording function.

The embodiment of the invention according to claim 39 enables the design of the recording medium and the data that have been prerecorded by the provider to be correlated with one another.

The embodiment of the invention according to claim 40 enables in particular that the prerecording of data onto mobile recording media by the provider can also be used in connection with advertising and marketing activities. For example, it is possible that the recording media have an image, an audio file, or a small program which cannot be deleted from the recording medium and which, upon each use of the recording medium, can develop its advertising activity so that the marketing potential of mobile recording media is again increased.

The embodiment of the invention according to claim 41 enables to economically take advantage of competence in connection with providing mobile recording media with different decorative coatings and to thus further improve the sales of the product. Particularly suitable are services and auxiliary services relating to logistics, design, concepts, sales-enhancement, selling, and market research. For example, it is possible that the final consumer upon ordering via the Internet can define when and where the mobile recording medium is to be sent. It is also possible to provide an open customer database in which the customer can record, for example, important birthdays and via which the customer can also determine an automatic shipping in advance. It is furthermore possible to develop and provide individual marks or special collections, for example, for individual trade companies. In this connection, design and conceptional services can be important. Moreover, it is possible that, for example, by an integration of advertising communication into the designs of the mobile recording media an advertising and marketing option for third parties is made available and operated. It is also possible to make available trade contacts obtained as a result of sales of the mobile recording media to other interested companies so that a distribution offer can be built. In particular, in the case of a possible cooperation with companies in the field of the music industry or the fashion industry, it is possible that the resulting data collection can be used commercially, for example, in the context of market research.

The invention will be explained in more detail with the aid of the following examples.

### EXAMPLES

Mobile Recording Media for Use as a Gift

One embodiment resides in providing a collection of fashioned CD blanks for the field of gift articles. The CD blanks have designs that make them suitable for typical gift applications. For example, this collection has CD blanks with the message: “I miss you”, blanks with the message “All the best”, blanks with the message “Thank you”, and blanks with the message “I love you”. The different CD blanks have a special added value because of the use of suitable design means. For example, the collection has CD blanks that have partially holographic designs and blanks that are coated with a fragrance. All CD blanks of this collection are offered in high-quality cases which, with regard to their designs, are similar to the designs of the correlated CD blanks which, however, additionally have the function of a congratulatory card because of the presence of a field for writing. Individual CD blanks have additional shipping containers as supplemental articles. In connection with the collection, different color pens for future labeling are offered as supplemental articles. The CD blanks have also an access code that is covered by a coating that can be removed by scratching; this enables the user after purchasing the blank to access a data collection on the Internet which contains particularly suitable data for the selected CD blank. In this way, the user in connection with the purchase of a recording medium with the design “I love you” is offered a number of love songs for downloading while in connection with the purchase of a recording medium with the design “Thank you” a selection of recorded musical thank you messages is offered for downloading.

Mobile Recording Media for the Field of Art and Fashion

One embodiment resides in providing a collection of designed CD blanks for the field of art and fashion. The CD blanks have in this connection designs that are correlated to an artist or a work of art. Also, CD blanks are possible that have designs as they are typically used in the fashion area. As a special feature, the designs are correlated with the current fashion collections of a fashion designer so that the optical recording media can develop a marketing function for this fashion collection. A reinforcement of this effect is possible in that several differently designed cases when combined form a new theme so that a collector's series is made available. It is also possible that these CD blanks are distributed as free advertising material. It is moreover possible that these CD blanks are sold.

Mobile Recording Media for the Field of Photography

One embodiment resides in providing a collection of designed CD blanks for the field of photography. The CD blanks have designs that indicate the recording of digital photo data or video data. For example, designs such as “Our Baby”, “Our Wedding”, “Vacation Memories” are possible. Moreover, it is possible that the CD blanks are provided with cases that are book-shaped and are similar to photo albums. It is also possible that normal CD cases are provided that have an insertion means for printed photos so that the user can attach a photo in or on the case. It is also possible to provide an adhesive surface on the case onto which the user can apply a photo or a collage. It is also possible that in connection with these CD blanks a software is offered which enables in particular archiving and processing of digital photo data and video data. It is also possible that this software is provided on the recording medium and that this software can be used to record digital photo data on the remaining storage space of the recording medium.

Mobile Recording Medium for the Tourist Industry

A particular configuration of the CD blanks for the photo area are CD blanks in the tourist field. Within such a collection, CD blanks with touristic images can be offered onto which the user then can burn in particular vacation memories. Such a collection could offer designs such as “New Zealand 2002” or “Summer in the Caribbean”. It is also possible that such collections can be offered spatially separated, for example, in that a design relating to New Zealand is primarily sold in New Zealand and in that a design relating to the Caribbean is primarily offered in the Caribbean.

Mobile Recording Media for the Music Area

One embodiment resides in providing a collection of designed CD blanks for the field of music. The CD blanks have designs which represents, for example, different musicians or bands. The user has the possibility to burn onto these CD blanks individual compilations of his favorite music. It is possible that in connection with these CD blanks also access to recordable music data is offered, wherein it is also possible that, as a function of the design of the selected CD blanks, only certain data are made available. This can be realized, for example, in that, when purchasing the blank, an additional service of data recording is offered to the user and that the user must accept this service when purchasing. The user, for example, via the Internet or at a terminal at a retail location can select a CD blank designed with the image of a certain artist whereupon from a selection of music titles of this artist he can select certain titles and record them on the recording medium. In this way, it is possible to control that no data of other musicians are recorded onto the recording medium. As a special feature it is possible that the CD blanks are designed such that the data recorded thereon cannot be copied or copied only with difficulty. In this way, such recording media are also suitable for a targeted marketing of certain music titles.

Mobile Recording Media for Use in Advertisement and Marketing

One embodiment resides in providing a collection of designed CD blanks for the marketing and advertising area. The CD blanks have designs that develop a direct or indirect advertising effect for a product, a person, or a company. It is also possible that in addition a part of the storage space provided on the recording medium is already prerecorded with data by the provider and that these data develop an advertising effect. Particularly suitable data are image data, sound data, or software data. It is possible that such CD blanks are offered for free for advertising and marketing purposes. It is also possible that such CD blanks are sold.

1. A method concerning marketing and selling of mobile recording media,
characterized in that
several mobile recording media are offered to the user which recording media are designed at the manufacturing facility and without direct influence of the users such that on their surface at least partially at least two coats of color applications are applied that supplement one another to a decorative coating as a graphic illustration and do not represent primarily a product identification and/or a trademark identification and/or a manufacturer identification and/or line markings for improving written labeling and that the coats of color applications that supplement one another to a decorative coating as a graphic illustration differ from one another, individually or as a set, with regard to their configuration.

2. The method according to claim 1,
characterized in that
on the surface of at least one of the offered mobile recording media partially also a decorative coating of at least one color application is provided.

3. The method according to claim 1 or 2,
characterized in that
at least one of the offered recording media is provided with a case.

4. The method according to claim 3,
characterized in that
the surface of at least one case has at least partially a decorative coating comprised of at least one color application and/or at least partially at least two coats of color applications supplementing one another to a decorative coating.

5. The method according to claim 3 or 4,
characterized in that
on and/or in at least one offered case at least one additional mobile recording medium and/or at least one supplemental article is provided.

6. The method according to claim 5,
characterized in that
the surface of at least one supplemental article is at least partially provided with a decorative coating comprised of at least one color application and/or at least partially with at least two coats of color applications supplementing one another to a decorative coating.

7. The method according to one of the claims 1 to 6,
characterized in that
on and/or within at least one case at least one fastening device for a detachable arrangement of a supplemental article is provided.

8. The method according to one of the claims 1 to 7,
characterized in that
on and/or in at least one case at least one fastening device for a detachable arrangement of at least one recording medium is provided.

9. The method according to one of the claims 1 to 8,
characterized in that
at least one case is book-shaped or shaped like a folding card.

10. The method according to one of the claims 5 to 9,
characterized in that
at least one supplemental article is disc-shaped and is comprised of a hard and/or flexible material.

11. The method according to one of the claims 5 to 10,
characterized in that
at least one supplemental article is book-shaped or shaped like a folding card.

12. The method according to one of the claims 5 to 11,
characterized in that
at least one supplemental article is a writing, painting, or drawing device.

13. The method according to one of the claims 5 to 12,
characterized in that
at least one supplemental article is a shipping container and/or a storage container.

14. The method according to one of the claims 1 to 13,
characterized in that
at least one recording medium is located in a retail container.

15. The method according to claim 14,
characterized in that
the surface of at least one retail container has at least partially a decorative coating comprised of at least one color application and/or at least partially two coats of color applications supplementing one another to a decorative coating.

16. The method according to one of the claims 1 to 16,
characterized in that
on at least one of the surfaces of a recording medium and/or a case and/or a supplemental article and/or a retail container at least partially at least one color coat as a graphic illustration or at least two coats of color applications supplementing one another to a decorative coating as a graphic illustration is and/or are applied, based on which the respective object can be correlated with a graphic and/or artistic and/or musical and/or entertaining work and/or such a work or such a product, a thing associated therewith, or a figure associated therewith, or a person associated therewith, or several persons associated therewith, or a company associated therewith, or an event associated therewith.

17. The method according to one of the claims 1 to 16,
characterized in that
on at least one of the surfaces of a recording medium and/or a case and/or a supplemental article and/or an additional recording medium and/or a retail container at least partially a luminescent and/or reflective and/or fluorescent and/or phosphorescent layer is applied.

18. The method according to one of the claims 1 to 17,
characterized in that
on at least one of the surfaces of a recording medium and/or a case and/or a supplemental article and/or an additional recording medium and/or a retail container at least partially a holographic illustration of at least one object and/or at least one sign is applied.

19. The method according to one of the claims 1 to 18,
characterized in that
on at least one of the surfaces of a recording medium and/or a case and/or a supplemental article and/or an additional recording medium and/or a retail container at least partially a layer containing fragrances that can be released upon rubbing is applied.

20. The method according to one of the claims 1 to 19,
characterized in that
on at least one of the surfaces of a recording medium and/or a case and/or the supplemental article and/or an additional recording medium and/or a retail container at least partially a self-adhesive layer is supplied.

21. The method according to one of the claims 1 to 20,
characterized in that
on at least one of the surfaces of a recording medium and/or a case and/or a supplemental article and/or an additional recording medium and/or a retail container at least partially a layer removable by scratching is applied.

22. The method according to one of the claims 1 to 21,
characterized in that
at least one of the surfaces of the recording medium and/or the case and/or a supplemental article and/or an additional recording medium and/or the retail container is at least partially configured by an appropriate material selection and/or appropriate arrangement of the applied color coats and/or performing a surface treatment such that a future written labeling and/or printing is facilitated.

23. The method according to one of the claims 1 to 22,
characterized in that
among all available graphic designs, i.e., those of the mobile recording media and, if present, those of the cases and, if present, those of the supplemental articles, and, if present, those of the retail packages, at least two designs are present which in combination provide a themed series and/or a new theme.

24. The method according to one of the claims 1 to 23,
characterized in that
on at least one of the surfaces of a recording medium and/or a case and/or a supplemental article and/or a retail container at least partially at least one color coat as a graphic illustration or at least two coats of color applications supplementing one another to a decorative coating as a graphic illustration is and/or are applied, based on which the respective object can be correlated with a location and/or a city and/or a region and/or a country and/or a touristic environment and/or a tourist site.

25. The method according to one of the claims 1 to 24,
characterized in that
on at least one of the surfaces of a recording medium and/or a case and/or a supplemental article and/or a retail container at least partially at least one color coat as a graphic illustration or at least two coats of color applications supplementing one another to a decorative coating as a graphic illustration is and/or are applied, based on which the respective object can be correlated to a thing and/or a product and/or a trademark and/or a company and/or a figure and/or a person and/or several persons and/or an event and/or a point in time and/or a time period.

26. The method according to one of the claims 1 to 25,
characterized in that
in combination with the offered mobile recording media also the service of recording data on the mobile recording media and therefore producing a data carrier is offered.

27. The method according to claim 26,
characterized in that
an automated user platform is made available to the user of the service of data recording via a network and/or via a technical device at the retail location.

28. The method according to claim 26 or 27,
characterized in that
the user has the option of providing his own data for the purpose of data recording.

29. The method according to one of the claims 1 to 28,
characterized in that
suitable data for recording on mobile recording media are also offered to the user and/or the user, already upon purchasing the mobile recording medium, obtains usage rights on data suitable for recording on the mobile recording medium.

30. The method according to claim 29,
characterized in that
the data are offered via a network and/or via a technical device at the retail location and/or in cooperation with a third party provider.

31. The method according to one of the claims 29 or 30,
characterized in that
the offered data are pieces of music and/or images and/or films and/or videos and/or software.

32. The method according to one of the claims 26 to 31,
characterized in that
the user, upon purchasing the recording medium, must select data from a certain compilation of data that are recorded on the recording medium upon purchase.

33. The method according to one of the claims 32,
characterized in that
the user can expand the compilation of selectable data by his own data or by a certain kind of own data or by a certain quantity of own data.

34. The method according to claims 32 or 33,
characterized in that
by data recording upon purchase the possibility is excluded that at a later point in time other or additional data are recorded on the recording medium.

35. The method according to claims 32 or 33,
characterized in that the compilation of the selectable data and/or the supplementing possibilities by own data depends on which mobile recording medium has been selected for recording from the offered quantity of mobile recording media.

36. The method according to one of the claims 1 to 35,
characterized in that
at least one mobile recording medium is already prerecorded by the provider with data such that the user has available only a remaining portion of the storage capacity of the mobile recording medium for his own data recording.

37. The method according to claim 36,
characterized in that
the data prerecorded by the provider is a software.

30. The method according to claim 37,
characterized in that
this software is a control software for recording devices and/or a data archiving software and/or a software that simplifies or enables the use of the mobile recording medium.

39. The method according to one of the claims 36 to 38,
characterized in that
the data prerecorded by the provider is correlated with the design of the mobile recording medium.

40. The method according to one of the claims 36 to 39,
characterized in that
the data prerecorded by the provider can be associated with a thing and/or a product and/or a service and/or a person and/or several persons and/or a company and/or a location and/or an event and/or can develop an effect related thereto.

41. The method according to one of the claims 1 to 40,
characterized in that
in combination with this method services and auxiliary services relating to logistics and/or design and/or concepts and/or sales-enhancement and/or sales and/or market research are offered or performed for the user and/or for a third party.
